(19) United States
(12) Patent Application Publication
(10) Pub. No.: US 2012/0043106 A1
(43) Pub. Date: Feb. 23, 2012

(54) Junction box with spacer

(76) Inventors: Michael Richter, Schalksmuehle (DE); Dennis Gazke, Luedenscheid (DE)

(21) Appl. No.: 13/136,887

(22) Filed: Aug. 12, 2011

(30) Foreign Application Priority Data
Aug. 17, 2010 (DE) 102010034631.4-55

(51) Int. Cl. H02G 3/16

(52) U.S. Cl. 174/53

(57) ABSTRACT

A junction box, in particular for a solar module, the junction box including a housing with functional components arranged therein for connecting with solar module connecting contacts, wherein the housing of the junction box includes a spacer configured to fixate an additional junction box at a distance from the junction box supporting the spacer.

### RELATED APPLICATIONS

This patent application claims priority from and incorporates by reference German patent application 10 2010 034631.4-55 filed on Aug. 17, 1010.

### FIELD OF THE INVENTION

The invention relates to a junction box in particular for a solar module including a housing with functional components for connecting two connecting contacts at the solar module arranged therein.

### BACKGROUND OF THE INVENTION

A junction box of this type is disclosed in DE 10 2007 027 861 A1. This junction box is configured by the manufacturer to be mounted on solar modules through an automated production process. The junction box housing is provided with connecting conductors for putting out electricity generated by the solar module, wherein the connecting conductors are supported by a cable support. The cable support is used furthermore for supporting the junction box cover through which the junction box can be closed after being mounted at the solar module.

The cable support disclosed in DE 10 2007 027 861 A1 includes a so-called receiving pin which is used as an engagement point for a gripper of an assembly robot. According to this printed document the gripper engages the junction box at its outsides and engages the cable support at its receiving pin in order to provide the so-called connection set with a glue device for attachment at the solar module.

It can be derived from the figures of DE 10 2007 027 861 A1 that the receiving pin is also used for arranging plural cable supports on top of one another.

As described in DE 10 2007 027 861 A1 junction boxes are required which are pre-configured for fully automated production of solar modules, wherein the junction boxes have to be provided as required by fully automated production. For this purpose the junction boxes are stored stacked in magazines at the assembly line for removal through a production robot. A well defined arrangement of the particular stacked junction boxes within the magazine is required since the assembly robots can only adapt their grippers within a defined space to various positions of the junction boxes. Typically the correct position is provided through respective magazine racks. Alternatively it is conceivable that the junction boxes are applied to particular carrier materials in defined distances. Carrier materials of this type are then provided in a timed manner to the production robot according to the spacing of the junction boxes from one another.

In particular the prior art magazine racks for storing preconfigured junction boxes in a defined position have had a fair amount of problems. Typically the racks have a considerable height; however, they are comparatively narrow due to the dimensions of the junction boxes, so that the gripper device for retrieving the junction boxes has to move into a comparatively narrow and high channel, which places particular demands upon the control system. At the same time the magazine rack must be precisely positioned in order to prevent a collision with the gripper device while retrieving junction boxes.

### BRIEF SUMMARY OF THE INVENTION

Thus, it is an object of the invention to provide a new junction box which can be advantageously stored at assembly lines for solar modules.

The object is achieved by a junction box with a housing with functional components arranged therein for connecting with solar module connecting contacts, wherein the housing supports a spacer configured to fixate another junction box at a distance from the junction box supporting the spacer, in particular with the characterizing features, according to which the housing of the junction box includes a spacer through which another junction box can be arranged and fixated in position with respect to the junction box bearing the spacer.

By using at least one spacer preferably, however, three spacers the junction box according to the invention facilitates arranging junction boxes on top of one another thus forming storage stacks. The spacers are furthermore used for arranging the junction boxes at one another with positional fixation. Consequently a rack which prevents a movement of junction boxes relative to one another is not required anymore. The junction box stack is stable by itself.

In an advantageous embodiment it is provided that the junction box includes three spacers which form the corners of a triangle.

The arrangement of the spacers as corners of a triangle provides a very stable arrangement of the junction boxes on top of one another.

For producing and using the ensuing solar module it is advantageous that the spacer is supported in a disengageable manner in one of the supports of the junction box.

This embodiment facilitates removing the spacer before or after mounting the junction box at the solar module. Since the spacers are longer than the height of the junction box in order to provide a spacing of the junction boxes from one another, the entire height or transport height of the solar module can be reduced by removing the spacers.

It is advantageous when the spacer is arranged in the support through friction locking.

However, it is also conceivable that the spacers are connected at the junction box through zones with weakened material and removing the spacer from the junction box is provided through a separation along the zone with weakened material through a tool or through overload. However, supporting the spacer through friction locking is advantageous since a spacer of this type can be removed in a simple manner, for example, through moving it out of the support.

It is furthermore provided that the support of the junction box or the base of the spacer is provided with ribs which provide friction locking engagement between the support and the spacer. Through selecting the number of ribs the frictional force required for the support can be influenced easily.

For arranging plural junction boxes on top of one another through coupling the spacers of different junction boxes amongst one another it is provided that a head of an additional spacer is supported through friction locking in the receiver of the base.

Also for this coupling it is advantageous that the head or the receiver is provided with ribs for generating the friction locking engagement.

An exemplary embodiment is characterized in that the number of ribs for receiving the spacer or the head of the spacer is lower than the number of ribs of the spacer or the junction box or the base of the spacer.

The lower number of ribs between the receiver and the head compared to the number of ribs of support and base provides that the friction forces between the support and the base are greater than the friction forces between the receiver and the head of two spacers.

Considering that the junction boxes are arranged in a stack in which the head of the spacer of the first junction box is received in a receiver of the spacer of the second junction box, it is provided through frictional engagement with different strength that only the head and the receiver separate from one another as a matter of principle when removing a junction box from the stack, but the support and the base doe not separate from one another. Thus, each spacer remains arranged at the associated junction box when the junction box is retrieved and each spacer is removed at the earliest after retrieval and before mounting the associated junction box at the solar module. The spacers themselves can be collected and recycled.

### BRIEF DESCRIPTION OF THE DRAWINGS

The invention is subsequently described based on an embodiment with reference to drawings wherein:

FIG. 1 illustrates a junction box according to the invention in a top view;

FIG. 2 illustrates the junction box according to FIG. 1 in a perspective view;

FIG. 3 illustrates two junction boxes placed behind one another according to FIG. 1 in a perspective view;

FIG. 4 illustrates a partial sectional view of two junction boxes arranged on top of one another according to the section line IV-IV in FIG. 1;

FIG. 5 illustrates a spacer according to the invention in a lateral view;

FIG. 6 illustrates a sectional view of the spacer according to the sectional line VI-VI in FIG. 5;

FIG. 7 illustrates a perspective view of the spacer according to FIG. 5;

FIG. 8 illustrates a partial view of the junction box according to FIG. 1 illustrating a support device for a spacer;

FIG. 9 illustrates a partial view of the junction box according to FIG. 1 with a view of a support device according to FIG. 8 with an inserted spacer;

FIG. 10 illustrates a horizontal sectional view through the support device of the junction box according to FIG. 9 provided with the spacer;

FIG. 11 illustrates a horizontal sectional view of the base of the spacer with an inserted head of another spacer.

FIG. 12 illustrates a perspective view of a junction box schematically illustrating two centering bosses;

FIG. 13 illustrates a schematic view of a centering boss in a perspective view; and

FIG. 14 illustrates a vertical sectional view through the junction box according to FIG. 12 with centering bosses inserted.

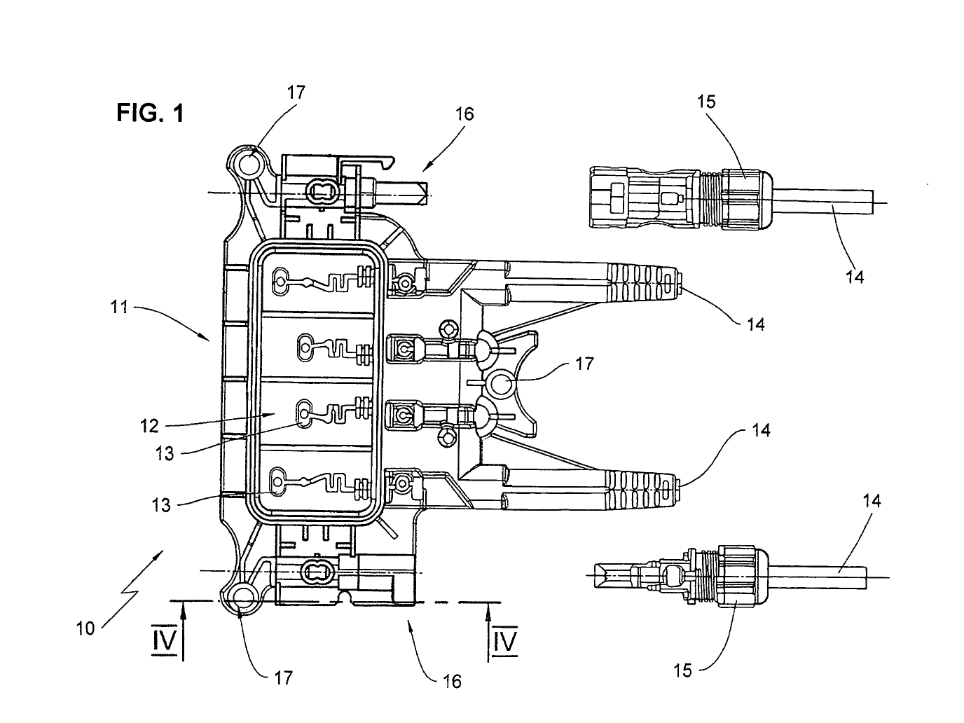

### DETAILED DESCRIPTION OF THE INVENTION

A junction box according to the invention for solar modules is designated overall with the numeral 10 in the drawings.

The junction box 10 includes a housing 11 which forms an inner cavity 12. Connection contacts 13 are arranged in the cavity 12 which are provided for connecting with contacts of the solar module which are not illustrated. The connection contacts 13 are electrically connected through functional components embedded in the housing material, like, for example, bypass diodes, with connecting conductors 14 leaving the housing 11, wherein ends of the connecting conductors are provided with plug-in connectors 15.

The interruption of the connecting conductors 14 illustrated herein between their exit from the junction box 10 and the end provided with plug connectors 15 is due to the illustration. In reality these are two respective connecting conductors 14 extending from the housing 11 to the plug connector 15.

The housing 11 of the junction box 10 forms mechanisms 16 on both sides of the inner cavity 12 which are plug-in complementary to the plug connectors 15, wherein the mechanisms 16 are used for supporting the plug connectors 15 at the junction box 10 for transportation and assembly. Thus, the mechanisms 16 are used for cable support.

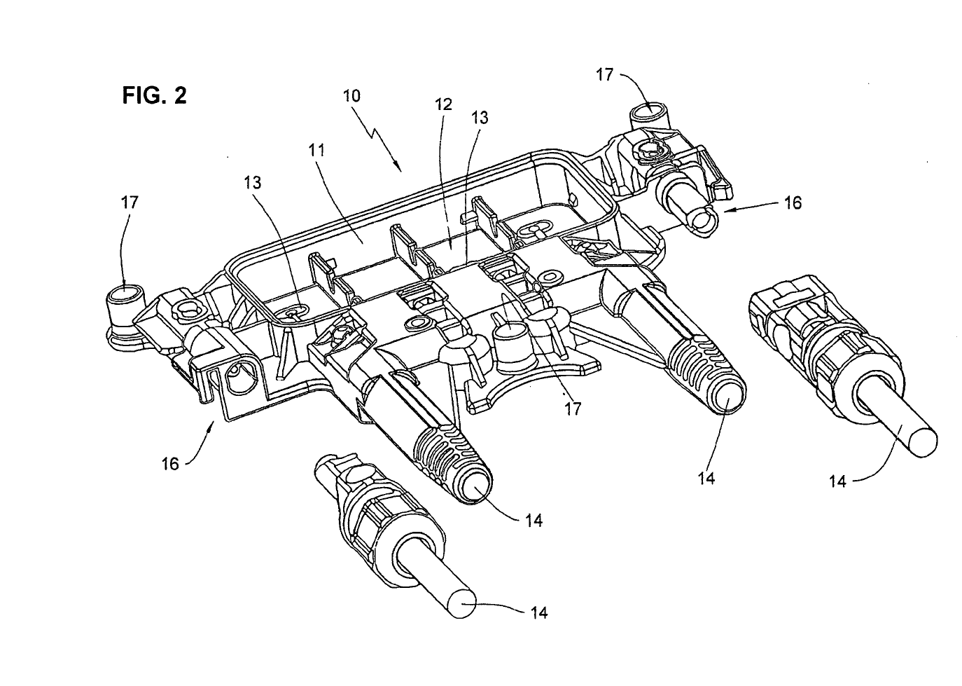

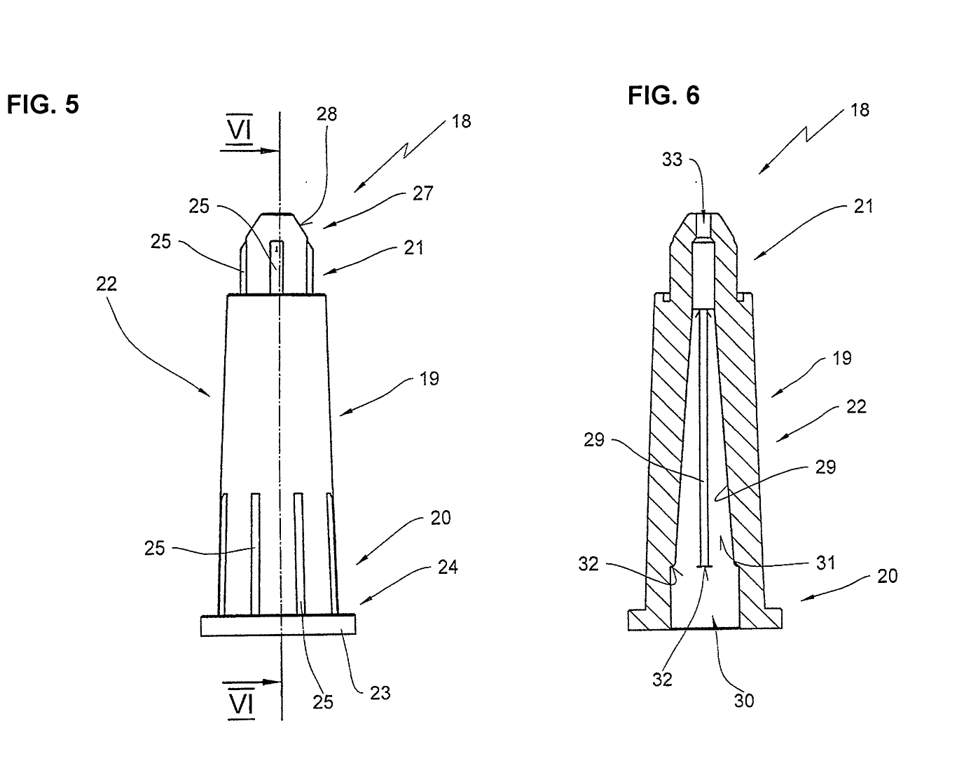

Additionally the housing 11 of the junction box 10 forms supports 17 which are used for receiving spacers 18, c.f. e.g. FIG. 5. The support 17 is configured as a hollow cylinder, in particular as a circular hollow cylinder as apparent, for example, from FIG. 2.

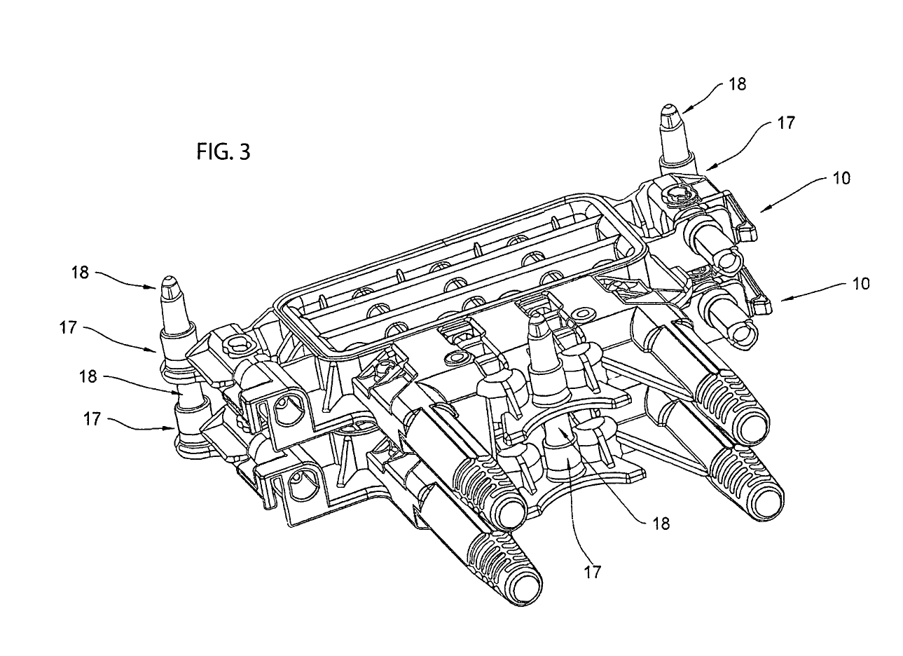

FIG. 3 illustrates an arrangement of two junction boxes 10 on top of one another. Thus, the spacers 18 are inserted into the supports 17 for each junction box 10. In the actual embodiment each junction box 10 forms three supports 17 respectively receiving one spacer 18.

The spacer 18 is illustrated in detail in FIGS. 5 through 7. It has a substantially cylindrical body which is overall designated with the numeral 19.

The circular cylindrical body 19 has slight conicity so that it also can be designated as a frustum. The element 19 has three portions. The lower portion is formed by the so-called base 20. The head 21 of the element 19 is arranged at the opposite end. A spacer 22 is configured between the base 20 and the head 21 which are configured at opposite ends of the element 19.

The base 20 includes approximately the portion of the element 19 which is arranged in the support 17 of a junction box 10. The base includes a base disc 23 forming the base of the element 19, wherein the base disc has a larger diameter than the element 19 and transitions into the element 19 through a shoulder 24 configured as a recess. The portion of the cylindrical element 19 joining the base disc 23 in as far as it is associated with the base 20 is provided with ribs 25 offset from one another in circumferential direction and parallel to the longitudinal axis of the spacer 18.

The transition from the spacer 22 of the element 19 to the head 21 is formed by a shoulder 26. The shoulder 26 is formed in that the head 21 of the spacer 18 is reduced with respect to its diameter relative to the spacer 22.

The head 21 is also provided with ribs 25. Also the ribs are offset from one another in circumferential direction and oriented parallel to the longitudinal axis of the spacer 18. Compared to the number of ribs 25 which support the base 20 the number of ribs 25 which support the head 21 is lower. The head 21 furthermore includes a support section 27 arranged at an upper end of the spacer 18, wherein the support section is provided with a conical circumferential surface 28.

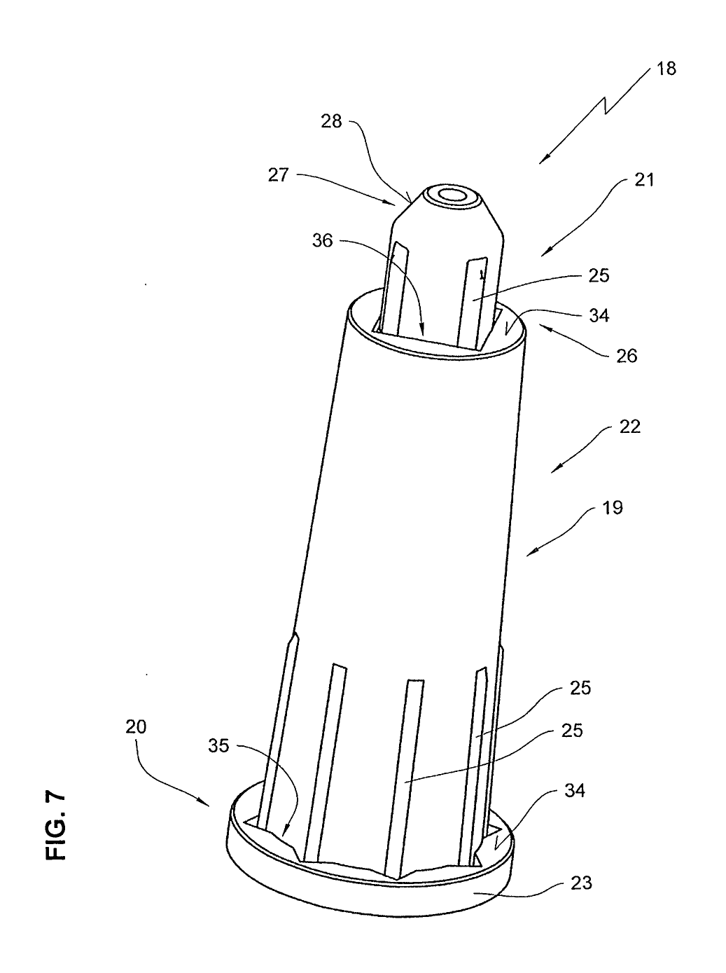

FIG. 6 illustrates a longitudinal sectional view through the spacer 18 according to the sectional line VI-VI in FIG. 5. As apparent in FIG. 6 the spacer 18 is hollow inside and initially includes a receiver 30 that is introduced into the base 20 and that is open towards the base of the spacer. Between the receiver 30 and the head 21 stabilization walls 29 are integrally molded in the interior of the spacer 18 at the inner circumferential surface 31. The wall surfaces 32 of the stabilization walls parallel to the base disc 23 define the receiver 30 towards the head 21 of the spacer 18.

The receiver 30 is used for inserting the head 21 of another spacer 18. Therefore the receiver is configured complementary to receive the head 21 of another spacer 18. The walls surfaces 32 form a stop for the insertion movement of the head 21 of another spacer 18. The conical circumferential surfaces 28 of the head 21 are used for facilitating an insertion into a receiver 30.

As evident eventually also from FIG. 6 the head 21 of the spacer 18 is provided with a longitudinal bore hole 33 which reaches into an interior of the spacer 18. The bore hole 33 in the head 21 of the spacer 18 facilitates pressure compensation when a head 21 of another spacer 18 penetrates the receiver 30. The air displaced by the volume reduction of the cavity of the spacer 18 can escape through the bore hole 33.

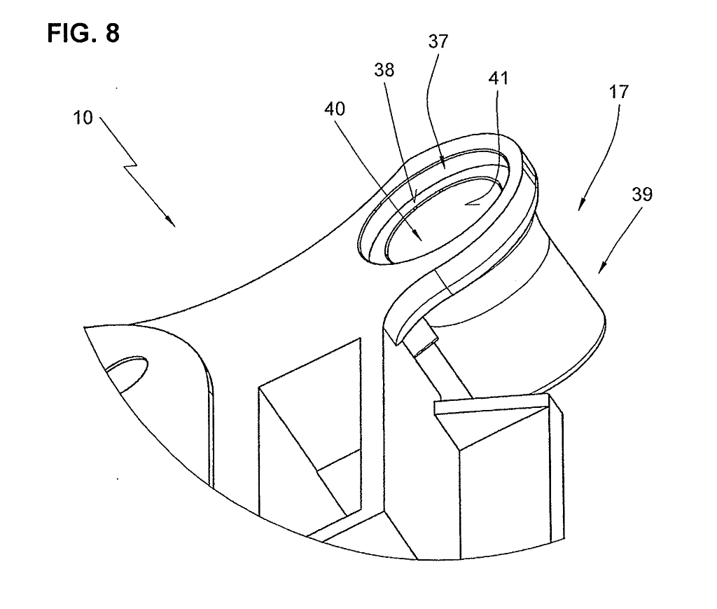

FIG. 7 illustrates the spacer 18 again in a perspective view. It is evident in particular that a groove is respectively fabricated in the stop surface 34 of the base disc 23 and of the shoulder 26. The groove 35 of the base disc 23 is approximately star-shaped, the groove of the shoulder 26 is approximately square. The grooves 35 and 36 are used for receiving material chips possibly coming off the ribs 25 when inserting the spacer 18 into a support 17 at the junction box or when inserting the head 21 into a receiver 30 of the spacer 18 which will be described in more detail infra.

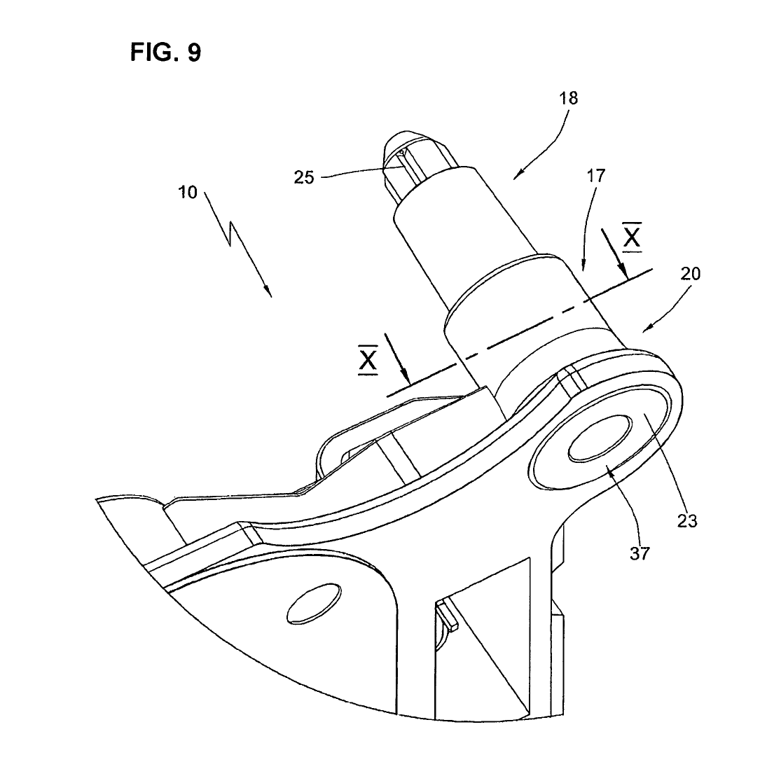

FIG. 8 illustrates the junction box 10 in a partial view. This is an enlarged detailed view of the support 17 of the junction box 10 from below.

The support 17 is substantially configured as a hollow cylinder and configured substantially with a complementary shape to the base 20 of the spacer 18. Thus, the support 17 initially includes a bore hole 37 with a larger diameter, wherein the bore hole receives the base disc of the base 20 when the spacer 18 is inserted. The stop surface 34 contacts the ring surface 38 of the support 17 when the spacer 18 is inserted. Thus, the annular surface 38 is used for defining the insertion depth of the spacer 18 into the support 17.

A hollow cylindrical section 39 with smaller diameter of the support 17 connects to the bore hole 37 with a comparatively larger diameter, wherein the cavity 40 of the hollow cylindrical section with smaller diameter is configured with a complementary conical shape according to the conicity of the spacer 18. However, it is essential that the inner surface of the hollow cylindrical section 39 of the support 17 is substantially planar and in particular does not include recesses that are complementary for receiving the ribs 25. The cavity 40 of the support 17 thus is only shape complementary to the base 20 of the spacer 18 in that it forms a base without ribs while only maintaining a particular clearance fit 42.

FIG. 9 substantially corresponds to the view of FIG. 8 besides the fact that a spacer 18 is now inserted into the support 17. As illustrated in this view the base disc 23 is completely received in the larger diameter bore hole 37 of the support 17.

The spacer 18 is fixated through friction locking in the support 17, wherein the friction locking is provided through the ribs 25 of the base 20. Since the ribs expand the outer circumference of the base 20, the receiver 17, however, does not provide any supplemental space for the ribs 25, a press fit is provided through inserting the spacers 18 and the friction locking engagement provided by the ribs 25.

When inserting the spacer 18 into the support 17 it can be provided that the ribs 25 do not plastically deform in the intended manner but that materials are removed in chips. In order to still provide a precisely fitted reception of the base disc 23 in the larger diameter bore hole 37, thus a substantially full surface contact of the contact surface 34 of the base disc 23 at the annular surface 38, the star-shaped grooves 35 illustrated in FIG. 7 are provided. When material is removed in chips the chips are received by the groove instead of moving between the stop surface 34 and the ring surface 38.

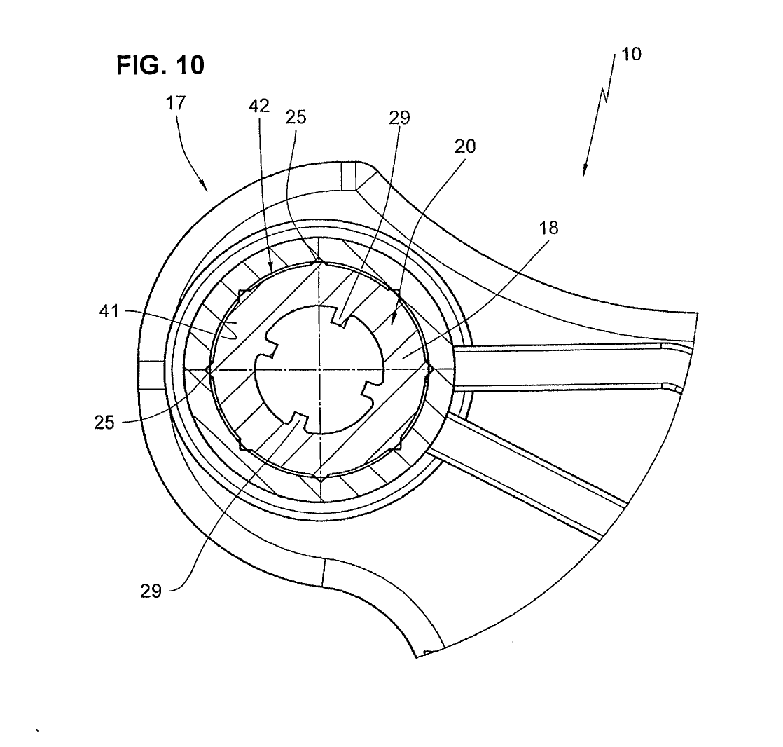

FIG. 10 illustrates a sectional view through the support 17 according to the sectional line X-X in FIG. 9 horizontally through the base 20 of the spacer 18. Reference is made initially to the clearance fit 42 between the base 20 and the inner surface 41 of the support 17. Also the ribs 25 are clearly visible which are arranged at the outer surface of the base 20 with a circumferential offset. The ribs 25 are overemphasized in FIG. 10. It appears that the ribs 25 significantly engage the inner surface 41 of the support 17.

It cannot be excluded that besides a plastic deformation of the ribs 25 also a deformation is provided at the inner surface 41 of the support 17 through inserting the spacer 18. However, it is appreciated that primarily the ribs 25 will deform. The overemphasis of the ribs 25 is only used for a better illustration of the ribs in FIG. 10.

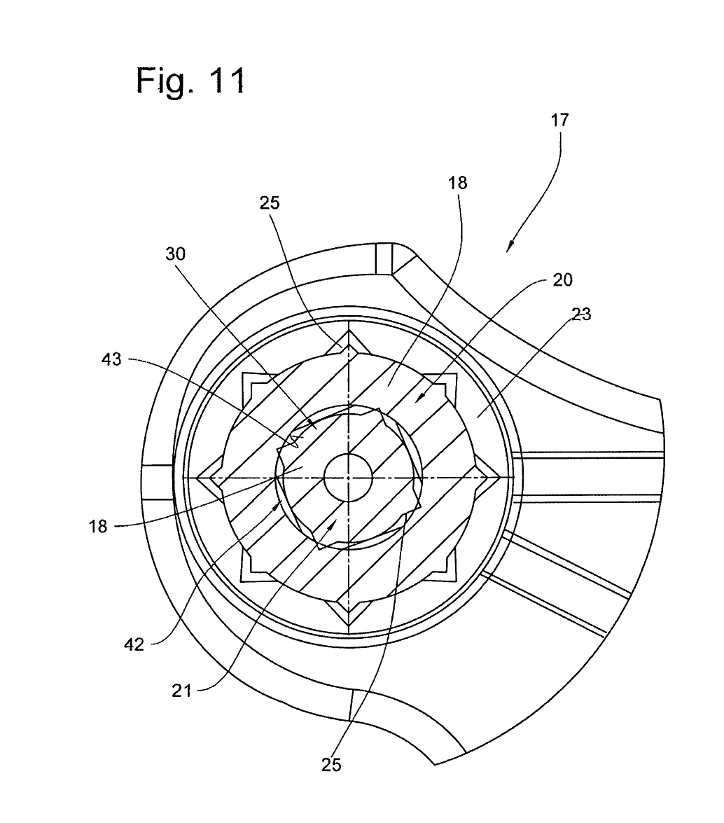

FIG. 11 also illustrates a horizontal sectional view of the support 17 of the junction box 10. The sectional plane is in the contact portion of the annular surface 38 and the stop surface 34 of the base disc 23. In this figure it is illustrated how a head 21 of another spacer 18 is arranged in the receiver 30 of the base 20 of a first spacer 18. Also here there is a clearance fit 42 between the outer circumferential surface of the head 21 that has no ribs and the receiver 30. Only the ribs 25 establish a friction locked contact between the inner surface 43 of the receiver 30 and the head 21. Consequently the head 21 is supported in a friction locked manner through a press fit in the receiver 30. Also here the ribs are overemphasized for illustration purposes like in FIG. 10. The recited square groove 36 is also used here for receiving possibly occurring chips when inserting the head 21 into the receiver 30.

It is apparent in FIG. 11 that the number of ribs 25 at a head 21 is smaller than the number of ribs 25 at a base 20. In the embodiment of FIG. 11 a ratio of approximately 2:1 was selected. When the materials of the spacer element 18 and of the support 17 are the same and the ribs 25 are sized identically at a head 21 with the ribs 25 at a base 20 a ratio of approximately 2:1 will also be achieved between the forces which occur when disengaging the closing connector between the support 17 and the base 20 or between the receiver 30 and the head 21.

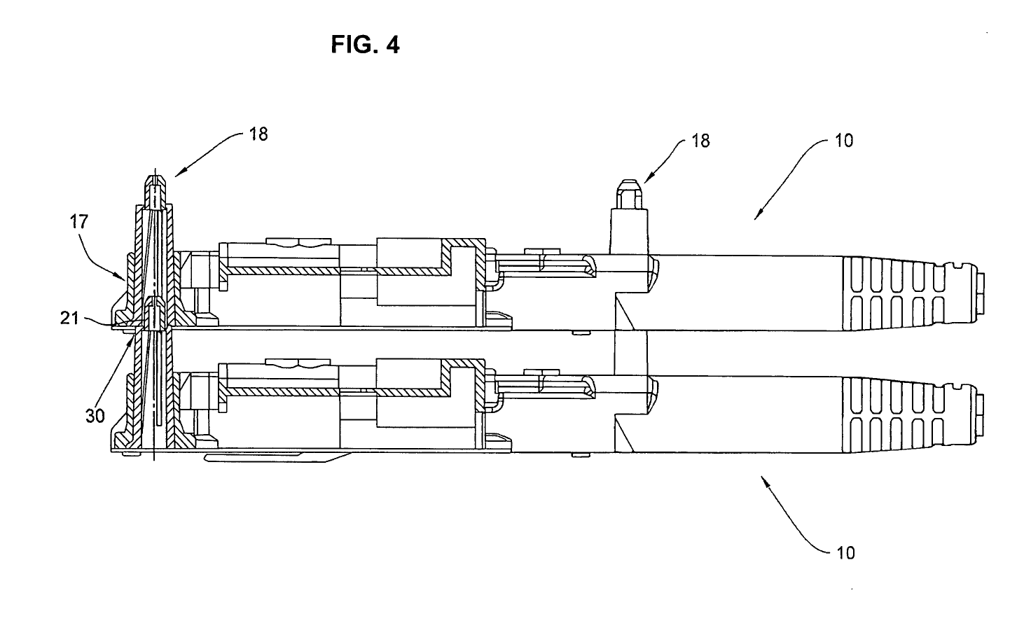

When junction boxes 10 are arranged on top of one another using the spacers 18 as illustrated in FIGS. 3 and 4 it can be achieved through the ratios of frictional forces recited supra and only defined by the ribs 25 that only the connection between receiver 30 and head 21 disengages when the upper junction box 10 is removed from the stack of junction boxes. This assures that the spacers 18 of each junction box 10 remain in the respective support 17. In another process step the spacer 18 can then be pushed out of the support 17. The junction box can then be mounted on a solar module without the spacer 18.

Furthermore FIG. 4 clearly illustrates the stacking system of the junction boxes 10. As evident from the vertical sectional view through the spacers 18 in FIG. 4 a respective head 21 of a first spacer 18 engages the receiver 30 of another spacer, so that the weight of the respectively next higher junction box is reacted through the spacers 18.

The junction boxes 10 are consequently arranged through arranging the spacers 18 on top of one another maintaining a distance and are arranged with stable positioning relative to one another.

In conclusion a new junction box 10 is illustrated including spacers for arranging plural junction boxes 10 on top of one another which satisfies the requirements of a fully automated production process of solar modules in an advantageous manner.

The following is disclosed in addition:

A) A spacer 18 for a junction box 10 for a solar module, wherein the spacer 18 is disengageably arranged at the junction box 10.

B) The spacer according to A), wherein the spacer 18 forms a head 21 and a base 20 at opposite ends, wherein the base 20 includes a receiver 30 for arranging the head 21 of another spacer 18 which is configured complementary at least with respect to its head 21.

C) The spacer according to B) wherein the spacer 18 includes ribs 25 at its base 20 for friction locked arrangement at the junction box 10 and additional ribs 25 at the receiver 30 of the base 20, wherein the additional ribs are used for friction locked support of another spacer which is configured receiver complementary at least with its head 21, or wherein the head 21 of the additional spacer 18 is provided with ribs 25 which are used for friction locked support in the receiver 30 of the base 20.

The following is disclosed in addition:

D) An arrangement of plural junction boxes 10 according to the preamble of patent claim 1 on top of one another, wherein one spacer 18 offsets the junction boxes 10 from one another and the spacer 18 of a first junction box 10 engages a head 21 in a receiver 30 of a base 20 of the spacer 18 of a second junction box 10.

E) An arrangement according to D), wherein the spacer 18 is configured according to one of the letters A-B.

F) An arrangement according to D), wherein the junction boxes 10 are configured according to one of the claims 1-9.

The following is illustrated in addition:

G) A junction box 10 in particular for a solar module including a housing 11 whose interior 12 is configured with functional components, wherein the housing 11 includes a centering recess for an engagement of a centering boss.

H) The junction box according to G), wherein the centering recess is a conical recess.

K) The junction box according to G) wherein a wall with a slanted surface is configured within the centering recess.

Additionally a junction box is disclosed, in particular for a solar module, including a housing whose cavity is configured with functional components. Junction boxes of this type are known, for example, from DE 10 2007 023 210. When transitioning to fully automated production of solar modules it is required to provide junction boxes which satisfy the requirements of a fully automated production process.

A junction box of this type is characterized in particular in that the housing includes a centering recess for engagement of a centering boss.

It is an advantage of this junction box that a centering of the junction box relative to the assembly tool can be provided when receiving the junction box through the gripper of a respective assembly robot.

It is another advantage that an alignment of the junction box can be provided subsequent to its mounting at the solar module through engagement of a centering boss in the centering recess.

Thus, it is possible to perform a possibly necessary readjustment of the junction box relative to the solar module subsequent to the actual assembly process of the junction box in a second process step.

An exemplary embodiment that provides the centering recess is a conical recess. Alternatively it is provided that a wall is configured with a slanted surface within the centering recess. Both embodiments have the advantage that the slanted surface or the conical shape of the centering recess in combination with a respectively configured centering boss substantially simplify the alignment of the junction box relative to the solar module.

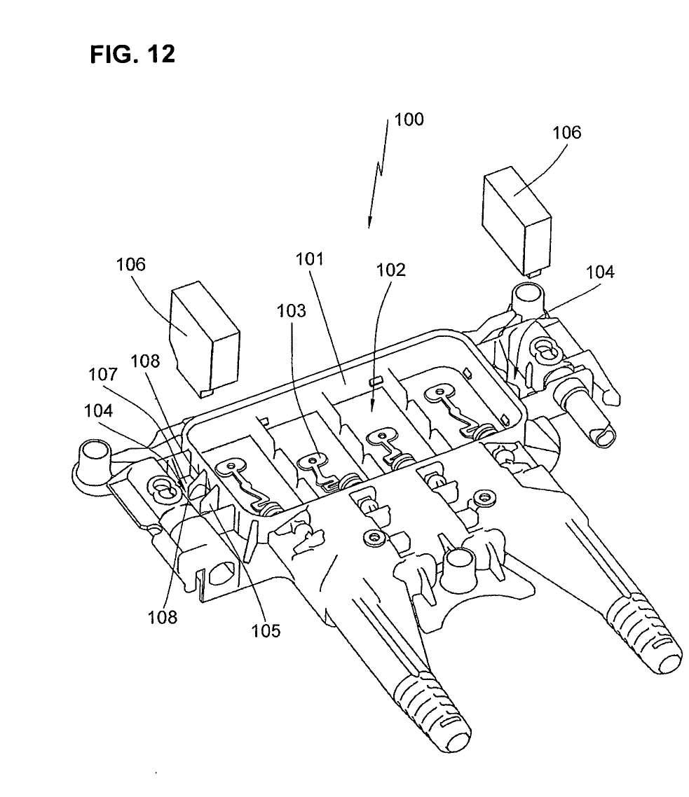

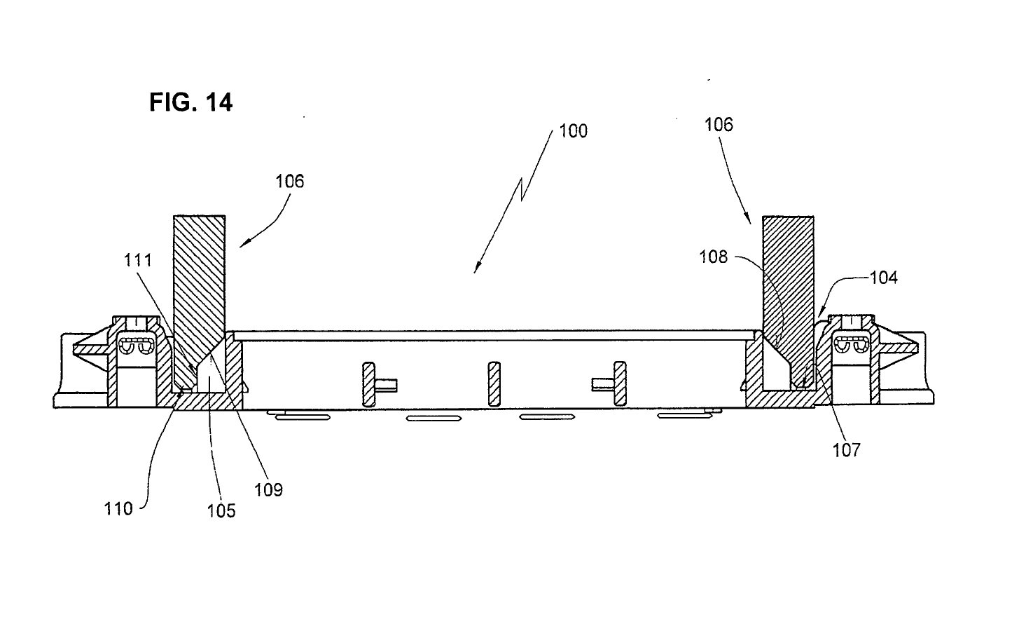

The disclosed junction box is described in more detail based on an exemplary embodiment with reference to drawing FIGS. 12-14, wherein:

A junction box is designated overall with the reference numeral 100 in the drawings.

The junction box 100 is formed by a housing 101 which encloses an inner cavity 102. The cavity includes connecting contacts for connecting with solar module conductors which are not illustrated. The cavity 102 can be closed through encasement and/or application of a cover which is not illustrated.

Centering recesses 104 are formed at the housing laterally from the cavity 102. Plural walls 105 are provided within the centering recesses, wherein the walls are oriented towards the centering boss 106 and are provided with slanted surfaces 108 descending towards the base 107 of the centering recess 104.

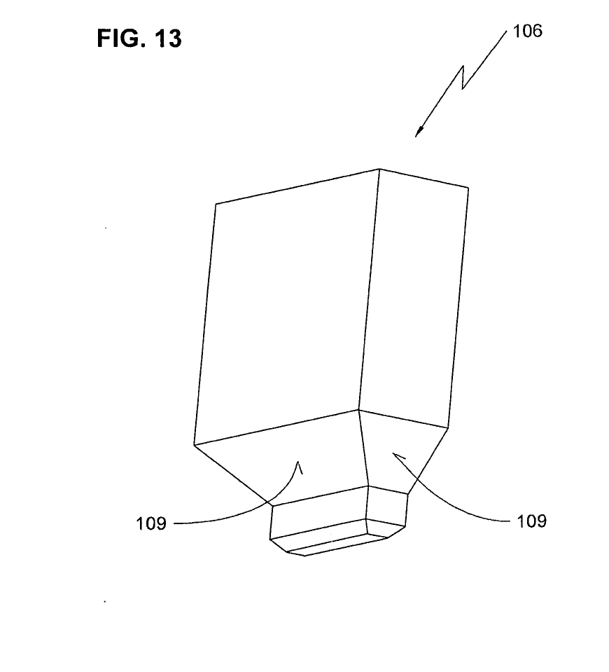

FIG. 13 illustrates the centering boss 106 in a schematic view from below wherein the centering boss is already schematically illustrated in FIG. 12.

The centering boss 106 is provided at its end oriented towards the junction box 100 with centering surfaces 109 conically tapering towards the junction box 100. A substantially cuboid section 110 adjacent to the centering surfaces 109 forms a contact device for the centering boss 106 and simultaneously forms a spacer for the centering surfaces 109 relative to the base 107 of the centering recess 104.

In order to center the junction box 100 relative to a gripper of an assembly robot or for centering the junction box 100 relative to a solar module that is not illustrated the centering bosses 106 move into the centering recesses 104. Thus at least one square section 110 slides along the slanted surfaces 108 of the walls 105 and thus moves the junction box 100 relative to the centering boss and consequently also relative to the solar module or relative to the gripper. Since the centering surfaces 109 of the centering boss 106 contact the slanted surfaces 108, fine centering of the junction box 100 is provided. The cuboid sections 110 contact the base 107 of the centering recess 104 and thus form a movement stop. Thus, they protect the walls 105 against a possible deformation through further insertion of the centering bosses 106 and thus protect the junction box 100 against damages. Thus, the slanted surfaces 106 transition into wall sections 11 declining perpendicular to the base 107.

In conclusion a junction box 100 is disclosed which facilitates an advantageous option for aligning the junction box 100 with reference to a gripper of an assembly robot or relative to the solar module through providing centering recesses.

### REFERENCE NUMERALS AND DESIGNATIONS

10 junction box
11 housing
12 inner cavity
13 connecting contact
14 connecting conductor
15 plug connector
16 mechanism
17 support
18 spacer
19 body of 18
20 base
21 head
22 spacer
23 base disc
24 shoulder
25 rib
26 shoulder
27 support section of 21
28 conical circumferential surface of 27
29 stabilization wall
30 receiver of 20
31 inner circumferential surface of 18
32 wall surface of 29
33 longitudinal bore hole of 21
34 stop surface
35 star shaped groove
36 square groove
37 bore hole with larger diameter
38 annular surface of 17
39 hollow cylindrical section
40 cavity of 39
41 inner surface of 39
42 fit clearance
43 inner surface of 30

### REFERENCE NUMERALS FOR FIGS. 12-14

100 junction box
101 housing
102 inner cavity
103 connecting contacts
104 centering recess
105 wall
106 centering boss
107 base of 104
108 slanted surface of 105
109 centering surface of 106
110 cuboid section
111 vertically declining wall sections of 105

What is claimed is:

1. A junction box, in particular for a solar module, the junction box comprising:
a housing with functional components arranged therein for connecting with solar module connecting contacts,
wherein the housing supports a spacer configured to fixate another junction box at a distance from the junction box supporting the spacer.

2. The junction box according to claim 1, wherein the junction box supports three spacers which form corner points of a triangle.

3. The junction box according to claim 1,
wherein the spacer includes a head and a base at opposite ends,
wherein the base includes a receiver for arranging a head of another spacer, and
wherein at least the head of the other spacer is configured complementary to the receiver.

4. The junction box according to claim 1, wherein the spacer is disengageably supported in a support of the junction box.

5. The junction box according to claim 4, wherein the spacer is arranged in the support through friction locking.

6. The junction box according to claim 5, wherein the support of the junction box or the base of the spacer is provided with ribs which provide friction locking between the support and the spacer.

7. The junction box according to claim 3, wherein the head of the other spacer is supported through friction locking in the receiver of the base.

8. The junction box according to claim 7, wherein the head or the receiver is provided with ribs for providing the friction locking.

9. The junction box according to claim 6, wherein the number of ribs of the receiver of the spacer or of the head of the spacer is smaller than the number of ribs of the support of the junction box or of the base of the spacer.

10. The junction box according to claim 2,
wherein the spacer includes a head and a base at opposite ends,
wherein the base includes a receiver for arranging a head of another spacer, and
wherein at least the head of the other spacer is configured complementary to the receiver.

11. The junction box according to claim 2, wherein the spacer is disengageably supported in a support of the junction box.

12. The junction box according to claim 3, wherein the spacer is disengageably supported in a support of the junction box.

13. The junction box according to claim 8, wherein the number of ribs of the receiver of the spacer or of the head of the spacer is smaller than the number of ribs of the support of the junction box or of the base of the spacer.
